(19) United States
(12) Patent Application Publication
(10) Pub. No.: US 2025/0210835 A1
(43) Pub. Date: Jun. 26, 2025

(54) BATTERY PACK

(71) Applicant: LG ENERGY SOLUTION, LTD., Seoul (KR)

(72) Inventors: Ju Hwan SHIN, Daejeon (KR); Hyoung Suk LEE, Daejeon (KR); Byung Do JANG, Daejeon (KR); Chang Hyeon YANG, Daejeon (KR)

(21) Appl. No.: 18/845,406

(22) PCT Filed: Sep. 15, 2023
(86) PCT No.: PCT/KR2023/013902

§ 371 Date: Sep. 9, 2024

(30) Foreign Application Priority Data
Sep. 16, 2022 (KR) 10-2022-0117231

(51) Int. Cl. H01M 50/682; H01M 10/48

(52) U.S. Cl. CPC H01M 50/682; H01M 10/482; H01M 10/486

(57) ABSTRACT

Aspects of the present disclosure relate to a battery pack for accommodating battery modules, including a pack case including a module area having a battery module seated therein. The pack case includes a base plate having a hollow structure with a hollow interior, and a side wall coupled along an edge of the base plate, wherein the base plate has a high-pressure liquefied gas filled inside the hollow structure.

### CROSS-REFERENCE TO RELATED APPLICATIONS

The present application is a National Phase entry pursuant to 35 U.S.C. § 371 of International Application No. PCT/KR2023/013902, filed on Sep. 15, 2023, and claims the benefit of and priority to Korean Patent Application No. 10-2022-0117231, filed in the Korean Intellectual Property Office on Sep. 16, 2022, the disclosures of both of which are incorporated herein by reference in their entirety for all purposes as if fully set forth herein.

### TECHNICAL FIELD

The present disclosure relates to a battery pack accommodating a battery module, and more specifically, according to certain aspects, the battery pack of the present disclosure is capable of rapidly cooling a battery module accommodated therein by vaporizing a vaporized gas filled at high pressure in the event of thermal runaway.

### BACKGROUND

The types of secondary batteries that are currently widely used include lithium-ion batteries, lithium polymer batteries, nickel-cadmium batteries, nickel-hydrogen batteries, and nickel-zinc batteries. The operating voltage of the unit cells of these secondary batteries is typically about 2.5V to 4.5V. Therefore, if a higher output voltage is required, a plurality of battery cells may be connected in series to form a battery pack. Also, depending on the charge and discharge capacity required for the battery pack, a plurality of battery cells may be connected in parallel to form a battery pack. Thus, the number of battery cells included in a battery pack may vary depending on the required output voltage or charge/discharge capacity.

When forming a battery pack by connecting a plurality of battery cells in series/parallel, it is common practice to first configure a battery module containing at least one battery cell, and to use that at least one battery module to add other components to form a battery pack.

FIG. 1 is a simplified perspective view of a conventional battery pack 10, characterized in that it accommodates a plurality of battery modules M inside, and the top and side parts of the battery modules M are protected by a top cover 20 and a side wall 30, respectively.

In the battery pack 10 in the above-mentioned form, since the battery module M is accommodated in a closed space, there is a risk that the internal space may become hot in the process of repeated charging and discharging. Therefore, the conventional battery pack 10 has the cooling water supplied through the cooling water supply pipe 40 connected with the cooling pipe inlet 50, as shown in FIG. 2, so that the lower part of the battery module M is continuously cooled by the cooling water. Since most of the heat generated inside the battery pack 10 is transferred to the bottom portion by conduction, this cooling method can be considered efficient.

However, even if cooling is provided in this manner, there are practical difficulties in preventing fires and explosions caused by thermal runaway phenomena in one of the battery modules M. In other words, since the thermal runaway occurs suddenly within a relatively short period of time, there are limitations in terms of controlling it with the existing cooling system.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

Accordingly, aspects of the present disclosure were conceived at least in part to solve the above-mentioned problems, and are aimed at rapidly cooling a battery pack when thermal runaway occurs in the battery modules that are accommodated in the battery pack.

Other objects and advantages of the present disclosure will be understood from the following description, and will become apparent from the embodiments of the present disclosure. It will also be readily apparent that the objects and advantages of the present disclosure may be realized by the means and combinations thereof disclosed in the claims of the patent.

According to aspects of the present disclosure, a battery pack accommodating a battery module, including a pack case including a module area where a battery module is seated is provided, wherein the pack case includes a base plate having a form of a hollow structure with a hollow interior; and a side wall coupled along a border of the base plate, wherein the base plate has a high-pressure liquefied gas filled inside the hollow.

The base plate further may include: an open hole connected to the inside of the hollow structure; and a sealing member coupled to the open hole to seal the inside of the hollow.

According to certain aspects, the battery pack includes a detecting sensor that is at least one of a temperature detecting sensor, a gas detecting sensor, and a pressure detecting sensor inside the pack case, wherein the sealing member may be removed from the open hole when an event is detected by the detecting sensor.

According to certain aspects, the open hole may be formed on the side of the base plate.

According to certain aspects, the base plate includes: a plurality of separation walls extending along a longitudinal direction of the pack case inside the hollow structure, and spaced apart and coupled along a width direction of the pack case to compartmentalize the inside of the hollow structure; and a plurality of hollow holes compartmentalized and formed by the separation wall, wherein one or more open holes may be formed at locations connected to each of the hollow holes.

According to certain aspects, the pack case further includes: a main bulkhead formed across the center and coupled to the base plate, wherein a plurality of module areas are formed at positions symmetrical to each other on both sides of the main bulkhead, and wherein the hollow structure may include a first hollow structure formed on one side of the main bulkhead and a second hollow structure formed on the other side of the main bulkhead on the inside of the base plate.

According to certain aspects, the liquefied gas may be in a gaseous state at room temperature.

According to certain aspects, the liquefied gas may be filled in a liquid state on the inside of the hollow structure of the base plate.

According to certain aspects, the liquefied gas may include carbon dioxide.

According to certain aspects, the base plate may include a plurality of cooling pipes that extend along a longitudinal direction of the pack case on the inside of the hollow structure.

According to aspects of the present disclosure, a battery pack can be rapidly cooled when thermal runaway occurs in an accommodated battery module to prevent a larger explosion and fire.

### BRIEF DESCRIPTION OF THE DRAWINGS

FIG. 1 is a perspective view of a conventional battery pack.

FIG. 2 shows a portion of the battery pack of FIG. 1.

FIG. 3 is a perspective view of a pack case included in a battery pack according to a first embodiment of the present disclosure.

FIG. 4 is an enlarged view of a portion of FIG. 3.

FIG. 5 illustrates a cooling water supply pipe connected to the cooling pipe inlet of the pack case of FIG. 3.

FIG. 6 illustrates a cooling pipe inlet and an open hole included in a base plate, according to an embodiment.

FIG. 7 illustrates a pair of hollows included on the inside of a base plate, according to an embodiment.

FIG. 8 is a cross-sectional view of a battery pack according to an embodiment of the present disclosure.

FIG. 9 is a perspective view of a pack case included in a battery pack according to a second embodiment of the present disclosure.

FIG. 10 is an enlarged view of a portion of FIG. 9.

FIG. 11 illustrates a cooling water supply pipe connected to the cooling pipe inlet of the pack case of FIG. 9.

FIG. 12 illustrates a cooling pipe inlet and an open hole included in a base plate, according to an embodiment.

FIG. 13 illustrates a plurality of hollow holes included on the inside of a base plate, according to an embodiment.

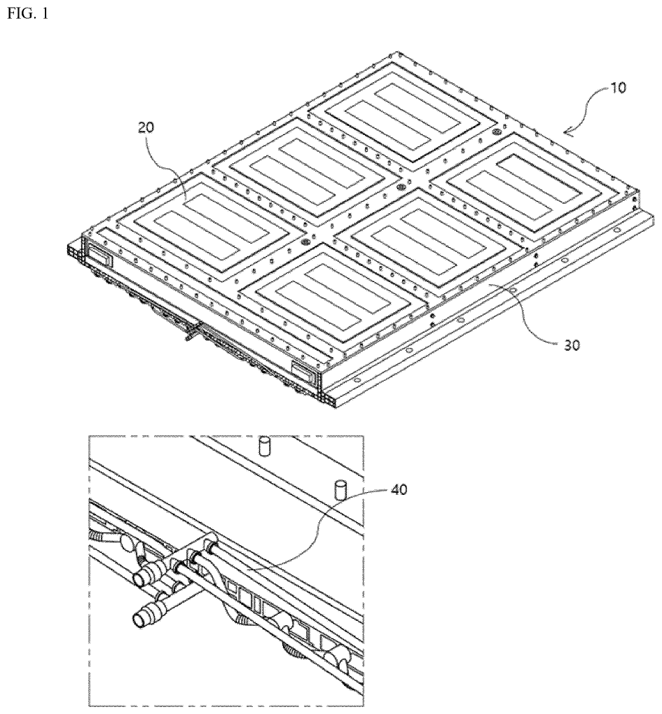

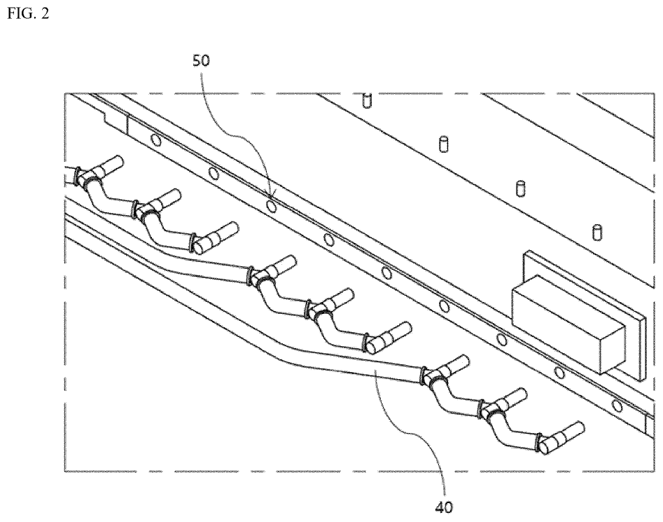

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

In addition, in describing aspects the present disclosure, detailed descriptions of related known configurations or features may be omitted where it is determined that such detailed descriptions would obscure the essence of the present disclosure.

The embodiments of the present disclosure are provided to illustrate the aspects of the disclosure more fully to those of ordinary skill in the art, and the shapes and sizes of the components in the drawings may be exaggerated, omitted, or shown schematically for clarity. Accordingly, the size or proportions of each component are not necessarily indicative of its actual size or proportions.

Aspects of the present disclosure relate to a battery pack accommodating a battery module, characterized in that the battery pack can be rapidly cooled by vaporizing a vaporized gas filled at high pressure in the event of thermal runaway from the battery module accommodated therein.

The battery pack of the present disclosure includes a pack case including a module area in which a battery module is seated, and a top cover that is coupled to the pack case to cover the top part of the seated battery module.

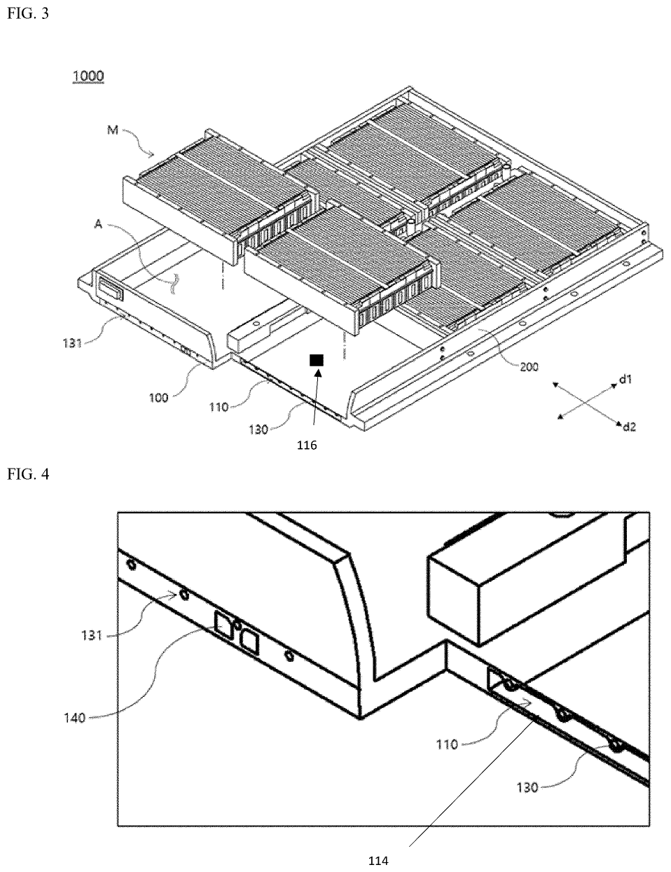

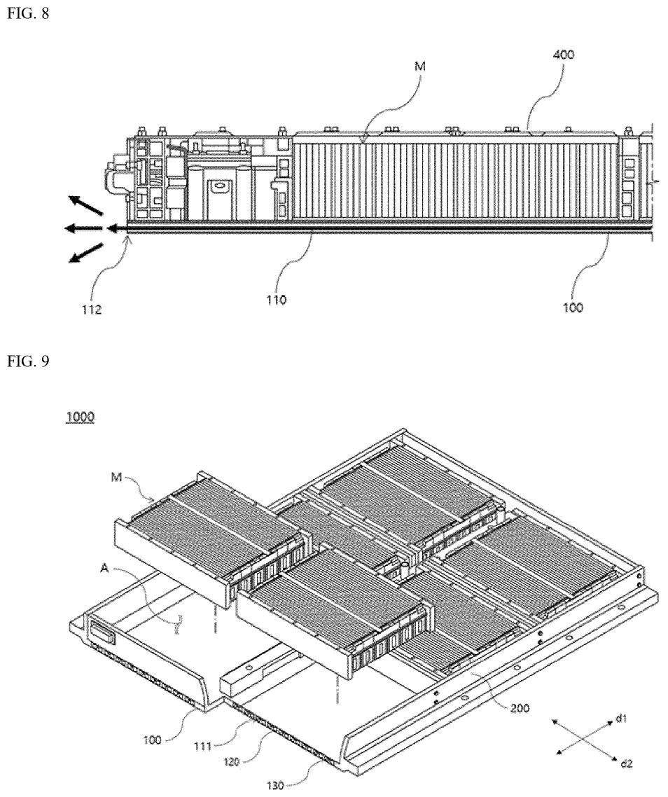

FIGS. 3 through 7 relate to a battery pack according to a first embodiment of the present disclosure, and FIGS. 8 through 11 relate to a battery pack according to a second embodiment of the present disclosure.

Hereinafter, each embodiment of the battery pack of the present disclosure will be described with reference to the drawings.

### FIRST EMBODIMENT

FIG. 3 is a perspective view of a pack case 1000 included in a battery pack according to a first embodiment of the present disclosure, and FIG. 4 is an enlarged view of a portion of FIG. 3.

The pack case 1000 according to aspects of the present disclosure includes a base plate 100 and a side wall 200, as shown in FIG. 3.

According to certain aspects, the base plate 100 serves to support the lower part of the battery module M, which is seated in the pack case 1000, and has the form of a hollow structure 110 with an empty and hollow interior 114.

The battery pack of the present disclosure may include a cooling pipe 130 through which cooling water from an external source flows to suppress and continuously cool the temperature of the pack case 1000 in which the battery module M is seated. According to certain aspects, the cooling pipe 130 is included in the base plate 100 on which the battery module M is seated.

According to certain aspects, the cooling pipe 130 is included within the hollow structure 110 of the base plate 100.

More specifically, according to certain aspects, the cooling pipe 130 extends along a longitudinal direction d1 of the pack case 1000, and a plurality of cooling pipes 130 can be spaced apart at a predetermined distance along a width direction d2 of the pack case 1000.

According to certain aspects, one side of the base plate 100 includes a cooling pipe inlet 131 into which cooling water supplied from an external source is introduced, the cooling pipe inlet 131 being configured and positioned with respect to a position of the cooling pipe 130 (and/or plurality of cooling pipes), such that it can be connected to each cooling pipe 130.

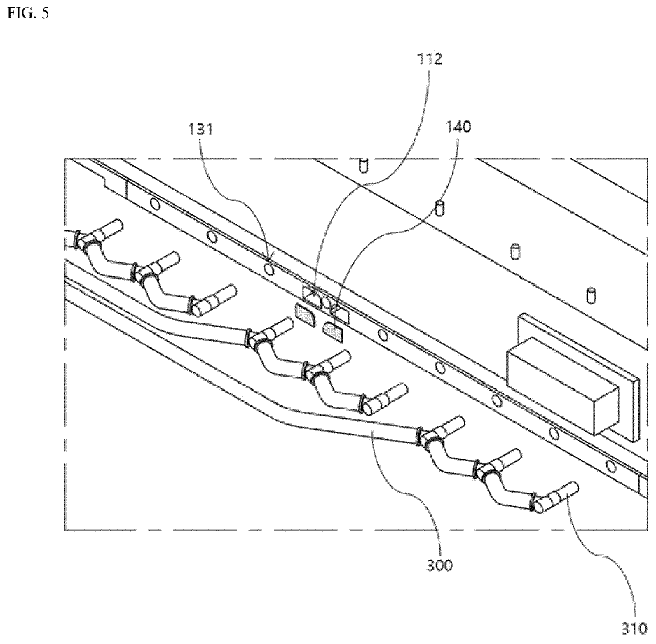

FIG. 5 illustrates a cooling water supply pipe 300 connected to the cooling pipe inlet 131 of the pack case 1000 of FIG. 3. Specifically, according to certain aspects, the cooling water supply pipe 300 may be coupled at its end with a connection member 310 that is inserted into the cooling pipe inlet 131 for supplying cooling water to each cooling pipe inlet 131. According to certain aspects, the connection member 310 connects the cooling water supply pipe 300 and the cooling pipe inlet 131 such that the cooling water supply pipe 300 and the cooling pipe 130 are connected to each other.

Thus, according to certain aspects, cooling water from the outside may flow through the cooling pipe 130 to cool the battery modules M seated on the top part of the base plate 100.

According to certain aspects, the side wall 200 is coupled along the edge of the base plate 100 to support the sides of all battery modules M seated in the module area A of the pack case 1000. The side wall can thus protect the battery modules M accommodated therein from external impacts, such as those applied to the sides of the battery pack.

The pack case 1000 of the present disclosure may further include a main bulkhead formed across the center and coupled to the base plate 100.

According to certain aspects, the module areas A are formed in positions symmetrical to each other on both sides of the main bulkhead, and may be plurally formed on each side of the main bulkhead, and battery modules M accommodated in the battery pack of the present disclosure may be seated side by side along the longitudinal direction d1 of the pack case 1000 on both sides of the main bulkhead.

According to certain aspects, the battery pack of the present disclosure is characterized in that a cooling pipe 130 is located inside the hollow structure 110 of the base plate 100, which is also filled with a liquified gas.

Inside the hollow structure 110 of the base plate 100, according to certain aspects, a cooling pipe 130 may be installed as shown in FIG. 4, and the space excluding the cooling pipe 130 may be filled with liquified gas at a high pressure. At this time, the pressure is preferably applied to such an extent that the liquified gas is in liquid form, and the liquified gas is filled inside the hollow structure 110 of the base plate 100 in a liquid state.

The liquified gas preferably includes a gas having a gaseous state at room temperature. More preferably, the liquefied gas includes carbon dioxide (CO₂).

According to certain aspects, the liquefied gas filled inside the hollow structure 110 in the liquid state may be released to the outside when an event occurs in the battery module M accommodated in the battery pack. For example, when a thermal runaway occurs in the battery module M, generating high-temperature gas or the like, causing the temperature of the entire battery pack to rise, the liquified gas filled in the liquid state vaporizes and is released to the outside and absorbs the heat of the battery pack. Through the above-mentioned endothermic phenomenon, according to certain aspects, the battery pack of the present disclosure can be rapidly cooled in a thermal runaway situation of the accommodated battery module M.

According to certain aspects, one side of the base plate 100 further includes a cooling pipe inlet 131 and an open hole 112 that is open to be connected to the inside of the hollow structure 110, as shown in FIGS. 3 through 5.

The open hole 112 may be an inlet for filling the liquified gas, and may be an outlet for releasing the filled liquefied gas, such as when the liquefied gas becomes vaporized. The open hole 112 may be coupled with a sealing member 140 for sealing the liquefied gas filled at high pressure.

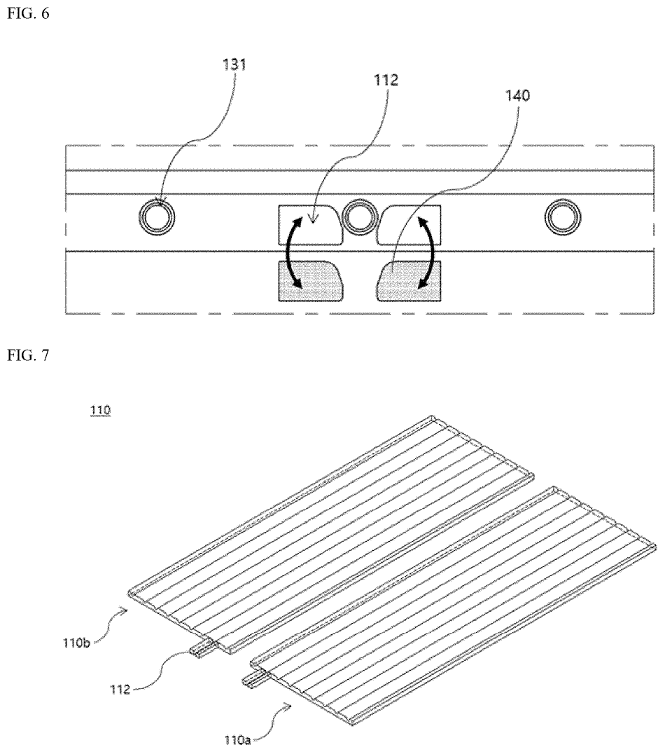

FIG. 6 illustrates a cooling pipe inlet 131 and an open hole 112 included in the base plate 100, wherein a sealing member 140 is seamlessly coupled to the open hole 112 to seal liquefied gas filled in the inner hollow structure 110 connected to the open hole 112 as shown in FIGS. 3 through 6.

According to certain aspects, the sealing member 140 is removed when thermal runaway occurs in the battery module M accommodated in the battery pack.

According to certain aspects, the battery pack of the present disclosure includes a detecting sensor 116 inside the pack case 1000, the detecting sensor being capable detecting an event such as thermal runaway of the battery module M.

The detecting sensor 116 may preferably be provided within the pack case 1000, and more specifically within the module area A of the pack case 1000.

The battery pack according to aspects of the present disclosure may perform rapid cooling by removing the sealing member 140 coupled to the open hole 112 of the base plate 100 at the same time as the detecting sensor 116 detects an event.

According to certain aspects, the detecting sensor 116 includes at least one of a temperature detecting sensor for detecting a change in temperature inside the module area A, a gas detecting sensor for detecting a gas generated inside the module area A, and a pressure detecting sensor for detecting a change in pressure inside the module area A.

Upon detection of an event by the detecting sensor 116, the sealing member 140 may rupture, or it may be otherwise separated by protruding from the open hole 112.

Thus, as the sealing member 140 is removed, according to certain aspects, the liquefied gas filled in a liquid state by high pressure is released through the open hole 112, e.g. as a vaporized gas, causing an endothermic phenomenon to occur in all areas of the base plate 100.

According to certain aspects, the hollow structure 110 may be formed in pairs, one on each side relative to the center of the base plate 100.

FIG. 7 illustrates a pair of hollow structures 110 included on the inside of the base plate 100.

Specifically, according to certain aspects, the hollow structure 110 includes a first hollow structure 110a formed on one side of the main bulkhead and a second hollow structure 110b formed on the other side of the main bulkhead on the inside of the base plate 100, as shown in FIG. 7. Thus, vaporized gas may be filled into the first hollow structure 110a located on one side of the base plate 100 and the second hollow structure 110b located on the other side, respectively.

According to certain aspects, each of the hollow structures 110 may be connected to at least one open hole 112.

According to certain aspects, the hollow structure 110 included in the battery pack according to the first embodiment of the present disclosure comprises an open space on one side of the center relative to the center of the base plate 100, and all of the filled liquefied gas is released, e.g. as a vaporized gas, when the sealing member 140 sealing the open hole 112 connected to the hollow structure 110 is removed.

FIG. 8 is a cross-sectional view of a battery pack according to aspects of the present disclosure, showing a partial cross-section when the battery pack is cut along a longitudinal direction d1 of the pack case 1000.

The arrows in FIG. 8 indicate the direction in which liquefied gas travels, e.g. in a vaporized state, and is released when the sealing member 140 of the open hole 112 is removed.

The vaporized gas is released in the direction shown in FIG. 8 and may rapidly cool the module area A located in the top part of the corresponding hollow structure 110 and the battery module M seated in the module area A.

The top cover 400 according to certain aspects may be any that are suitable, and, and thus a detailed description thereof is omitted.

### SECOND EMBODIMENT

The battery pack according to aspects of the present disclosure may have hollow structures 110 separated into a plurality of hollow structures within the base plate 100 that are independent of each other, and each separated hollow structure 110 may be formed with an open hole 112 individually connected to each other.

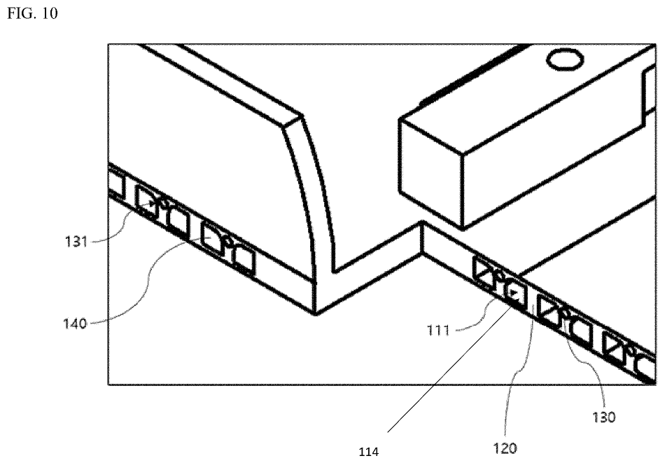

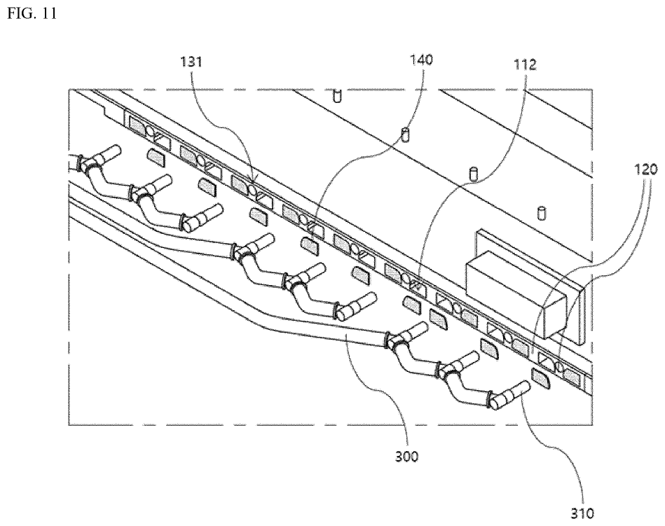

FIG. 9 is a perspective view of a pack case 1000 included in a battery pack according to a second embodiment of the present disclosure, FIG. 10 is an enlarged view of a portion of FIG. 9, and FIG. 11 shows a cooling water supply pipe 300 connected to a cooling pipe inlet 131 of the pack case 1000 of FIG. 9.

According to certain aspects, the pack case 1000 of the present disclosure includes a base plate 100 and a side wall 200, as shown in FIG. 9.

According to certain aspects, the base plate 100 serves to support the lower part of the battery module M, which is seated in the pack case 1000, and has the form of a hollow structure 110 with an empty and hollow interior 114.

The battery pack of the present disclosure may include a cooling pipe 130 through which cooling water from an external source flows to suppress and continuously cool the temperature of the pack case 1000 in which the battery module M is seated. According to certain aspects, the cooling pipe 130 is included in the base plate 100 on which the battery module M is seated.

According to certain aspects, the cooling pipe 130 is included within the hollow structure 110 of the base plate 100.

More specifically, according to certain aspects, the cooling pipe 130 extends along a longitudinal direction d1 of the pack case 1000, and a plurality of cooling pipes 130 can be spaced apart at a predetermined distance along a width direction d2 of the pack case 1000.

According to certain aspects, one side of the base plate 100 includes a cooling pipe inlet 131 into which cooling water supplied from an external source is introduced, the cooling pipe inlet 131 being formed in correspondence with a position of the cooling pipe 130 to be connected to each cooling pipe 130.

According to certain aspects, the cooling water supply pipe 300 may be coupled at its ends with a connection member 310 that is inserted into the cooling pipe inlet 131 for supplying cooling water to each cooling pipe inlet 131. According to certain aspects, the connection member 310 connects the cooling water supply pipe 300 and the cooling pipe inlet 131 such that the cooling water supply pipe 300 and the cooling pipe 130 are connected to each other.

Thus, according to certain aspects, cooling water flowing from the outside may flow through the cooling pipe 130 to cool the battery module M seated on the top part of the base plate 100.

According to certain aspects, the side wall 200 is coupled along the edge of the base plate 100 to support the sides of all battery modules M seated in the module area A of the pack case 1000. The side wall 200 may thus protect the battery modules M accommodated therein from external impacts, such as those applied to the sides of the battery pack.

The pack case 1000 of the present disclosure may further include a main bulkhead formed across the center and coupled to the base plate 100.

According to certain aspects, the module areas A are formed in positions symmetrical to each other on both sides of the main bulkhead, and may be plurally formed on each side of the main bulkhead, and battery modules M accommodated in the battery pack of the present disclosure may be seated side by side along the longitudinal direction d1 of the pack case 1000 on both sides of the main bulkhead.

According to certain aspects, the battery pack of the present disclosure not only has a cooling pipe 130 located inside the hollow structure 110 of the base plate 100, as shown in FIG. 10, but is also filled with liquefied gas.

Inside the hollow structure 110 of the base plate 100, according to certain aspects, a cooling pipe 130 may be installed as shown in FIG. 10, and the space excluding the cooling pipe 130 may be filled with liquefied gas at a high pressure. At this time, the pressure is preferably applied to such an extent that the liquefied gas is in liquid form, and the liquefied gas is filled inside the hollow structure 110 of the base plate 100 in a liquid state.

The liquefied gas preferably includes a gas having a gaseous state at room temperature. More preferably, the liquefied gas includes carbon dioxide (CO₂).

According to certain aspects, the liquefied gas filled inside the hollow structure 110 in the liquid state may be released to the outside when an event occurs in the battery module M accommodated in the battery pack. For example, when a thermal runaway occurs in the battery module M, generating high-temperature gas or the like, causing the temperature of the entire battery pack to rise, the liquefied gas filled in the liquid state vaporizes and is released to the outside and absorbs the heat of the battery pack. Through the above-mentioned endothermic phenomenon, according to certain aspects, the battery pack of the present disclosure may be rapidly cooled in a thermal runaway situation of the accommodated battery module M.

According to certain aspects, one side of the base plate 100 further includes a cooling pipe inlet 131 and an open hole 112 that is open to be connected to the inside of the hollow structure 110, as shown in FIGS. 9 through 11.

The open hole 112 may be an inlet for filling the liquesfied gas, and may be an outlet for releasing the filled liquefied gas, such as when the liquefied gas becomes vaporized. The open hole 112 may be coupled with a sealing member 140 for sealing the liquefied gas filled with a high pressure.

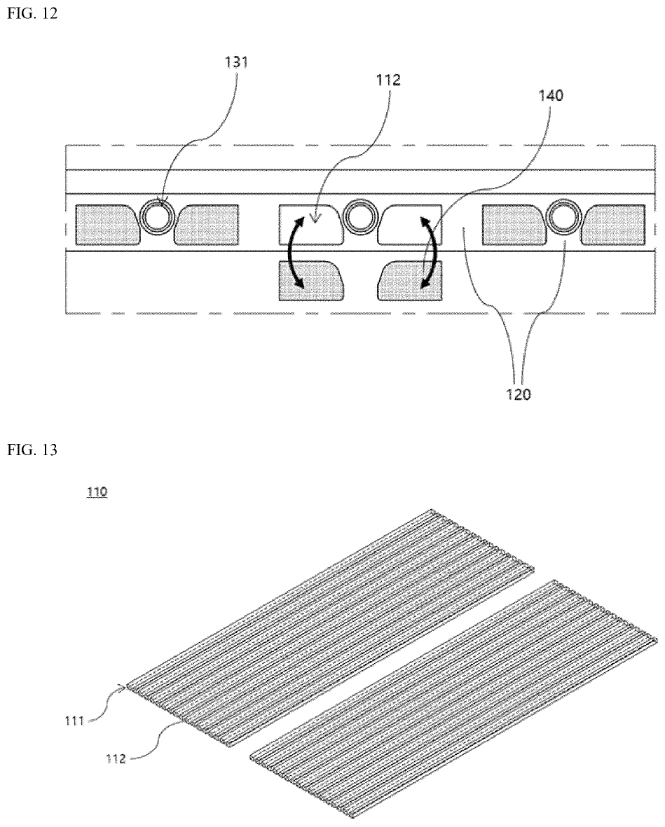

FIG. 12 illustrates a cooling pipe inlet 131 and an open hole 112 included in the base plate 100, wherein a sealing member 140 is seamlessly coupled to the open hole 112 as shown in FIGS. 9 through 12 to seal the liquefied gas filled in the inner hollow structure 110 connected to the open hole 112.

According to certain aspects, the sealing member 140 is removed when thermal runaway occurs in the battery module M accommodated in the battery pack.

According to certain aspects, the battery pack of the present disclosure includes a detecting sensor 116 inside the pack case 1000, the detecting sensor being capable of detecting an event such as thermal runaway of the battery module M.

The detecting sensor 116 may preferably be provided within the pack case 1000, and more specifically within the module area A of the pack case 1000.

The battery pack according to aspects of the present disclosure may perform rapid cooling by removing the sealing member 140 coupled to the open hole 112 of the base plate 100 at the same time as the detecting sensor 116 detects an event.

According to certain aspects, the detecting sensor 116 includes at least one of a temperature detecting sensor for detecting a change in temperature inside the module area A, a gas detecting sensor for detecting a gas generated inside the module area A, and a pressure detecting sensor for detecting a change in pressure inside the module area A.

Upon detection of an event by the detecting sensor 116, the sealing member 140 may rupture, or it may be otherwise separated by protruding from the open hole 112.

Thus, as the sealing member 140 is removed, according to certain aspects, liquefied gas filled to a liquid state by high pressure is released through the open hole 112, e.g. as a vaporized gas, causing an endothermic phenomenon to occur in all areas of the base plate 100.

In particular, according to certain aspects, the battery pack according to the second embodiment of the disclosure may includes a plurality of separation walls 120 that compartmentalize the hollow structure 110 of the base plate 100 in the width direction d2 of the pack case 1000, with a plurality of hollow holes 111 being compartmentalized and formed by the separation walls 120.

According to certain aspects, the separation wall 120 may be disposed between a pair of cooling pipes 130 formed at the cooling pipe locations and being adjacent as shown in FIGS. 10 through 12 to compartmentalize the interior space within the hollow structure 110.

FIG. 13 illustrates a plurality of hollow holes 111 included within the base plate 100.

According to certain aspects, the hollow holes 111 are formed by being spaced apart at predetermined distance as shown in FIG. 13. More specifically, according to certain aspects, the hollow holes 111 included in the battery pack according to the second embodiment are those in which the interior space inside of a first hollow structure 110a and a second hollow structure 110b included in the battery pack according to the first embodiment are compartmentalized by a plurality of separation walls 120, such that one hollow hole 111 may be formed with a corresponding one open hole 112, and each open hole 112 may be coupled with a sealing member 140 as shown in FIGS. 11 and 12.

Thus, according to certain aspects, by including a plurality of hollow holes 111 filled with liquefied gas, a battery pack according to the second embodiment of the present disclosure may be capable of rapidly cooling more detailed areas by optionally removing sealing members 140 corresponding to the hollow holes 111.

Aspects of the present disclosure have been described in more detail above with reference to the drawings and embodiments. However, it is to be understood that the configurations shown in the drawings or embodiments described herein are only one embodiment of the disclosure and do not represent all of the technical ideas of the disclosure, and that there may be various equivalents and modifications that may replace them at the time of filing the present application.

### REFERENCE NUMERALS

10: (CONVENTIONAL ART) BATTERY PACK
20: (CONVENTIONAL ART) TOP COVER
30: (CONVENTIONAL ART) SIDE WALL
40: (CONVENTIONAL ART) COOLING WATER SUPPLY PIPE
50: (CONVENTIONAL ART) COOLING PIPE INLET
1000: PACK CASE
100: BASE PLATE
110: HOLLOW STRUCTURE
110a: FIRST HOLLOW STRUCTURE
110b: SECOND HOLLOW STRUCTURE
111: HOLLOW HOLE
112: OPEN HOLE
114: HOLLOW INTERIOR
116: DETECTING SENSOR
120: SEPARATION WALL
130: COOLING PIPE
131: COOLING PIPE INLET
140: SEALING MEMBER
200: SIDE WALL
300: COOLING WATER SUPPLY PIPE
310: CONNECTION MEMBER
400: TOP COVER
A: MODULE AREA
M: BATTERY MODULE
d1: LONGITUDINAL DIRECTION
d2: WIDTH DIRECTION

1. A battery pack accommodating a battery module, comprising:
a pack case including a module area where a battery module is seated, wherein
the pack case comprises:
a base plate having a form of a hollow structure with a hollow interior; and
a side wall coupled along a border of the base plate,
wherein
the base plate has a high-pressure liquefied gas filled inside the hollow interior.

2. The battery pack of claim 1, wherein
the base plate further comprises:
an open hole connected to an inside of the hollow structure; and
a sealing member coupled to the open hole to seal the inside of the hollow structure.

3. The battery pack of claim 2, wherein
the battery pack comprises a detecting sensor that is at least one of a temperature detecting sensor, a gas detecting sensor, and a pressure detecting sensor inside the pack case, and wherein
the sealing member is removed from the open hole when an event is detected by the detecting sensor.

4. The battery pack of claim 2, wherein
the open hole is formed on the side of the base plate.

5. The battery pack of claim 2, wherein
the base plate comprises:
a plurality of separation walls extending along a longitudinal direction of the pack case inside the hollow structure, and spaced apart and coupled along a width direction of the pack case to compartmentalize the inside of the hollow structure; and
a plurality of hollow holes compartmentalized and formed by the plurality of separation walls, wherein
one or more open holes are formed at locations connected to each of the hollow holes.

6. The battery pack of claim 1, wherein
the pack case further comprises:
a main bulkhead formed across the center of the base plate and coupled to the base plate, wherein
a plurality of module areas are formed at positions symmetrical to each other on both sides of the main bulkhead, and wherein
the hollow structure comprises a first hollow structure formed on one side of the main bulkhead and a second hollow structure formed on the other side of the main bulkhead on the base plate.

7. The battery pack of claim 1, wherein
the liquefied gas is in a gaseous state at room temperature.

8. The battery pack of claim 1, wherein
the liquefied gas is filled in a liquid state on the inside of the hollow structure of the base plate.

9. The battery pack of claim 1, wherein
the liquefied gas includes carbon dioxide.

10. The battery pack of claim 1, wherein
the base plate includes a plurality of cooling pipes extending along a longitudinal direction of the pack case on the inside of the hollow structure.
